(19) United States
(12) Patent Application Publication
(10) Pub. No.: US 2021/0390482 A1
(43) Pub. Date: Dec. 16, 2021

(54) SMART SERVICE ROUTING USING MACHINE LEARNING

(71) Applicant: PETER L. REX, Bellevue, WA (US)

(72) Inventor: PETER L. REX, Bellevue, WA (US)

(21) Appl. No.: 17/243,262

(22) Filed: Apr. 28, 2021

Related U.S. Application Data
(60) Provisional application No. 62/704,226, filed on Apr. 28, 2020.

(51) Int. Cl. G06Q 10/06; G06Q 30/06; G08G 1/01

(52) U.S. Cl. CPC G06Q 10/06315; G06Q 30/0625; G08G 1/0137; G06Q 30/0605; G06Q 10/06313; G06Q 30/0639

(57) ABSTRACT

At least one computer-readable medium on which are stored instructions that, when executed by one or more processing devices, enable the one or more processing devices to perform a method. The method includes the steps of receiving from a user via an electronic device a request for a good or a service, receiving via the electronic device the geographic location of the user, and determining an optimal provider of the good or service based on the type of good or service and the geographic location of the user.

### PRIORITY CLAIM

This application claims priority from U.S. Provisional Application Ser. No. 62/704,226 filed Apr. 28, 2020, the entirety of which is hereby incorporated by reference as if fully set forth herein.

### BACKGROUND

The delivery of goods and services needs improved speed and efficiency of service routing, lowered cost of services and goods to the consumer/client, and increased revenue of pros and/or providers of goods.

### DRAWING FIGURES

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a schematic illustration of a selection engine according to an embodiment; and

FIG. 4 is a functional block diagram of an exemplary operating environment in which an embodiment of the invention can be implemented.

### DETAILED DESCRIPTION

This patent application is intended to describe one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be described in the general context of computer-executable instructions, such as program modules, being executed by a processing device having specialized functionality and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

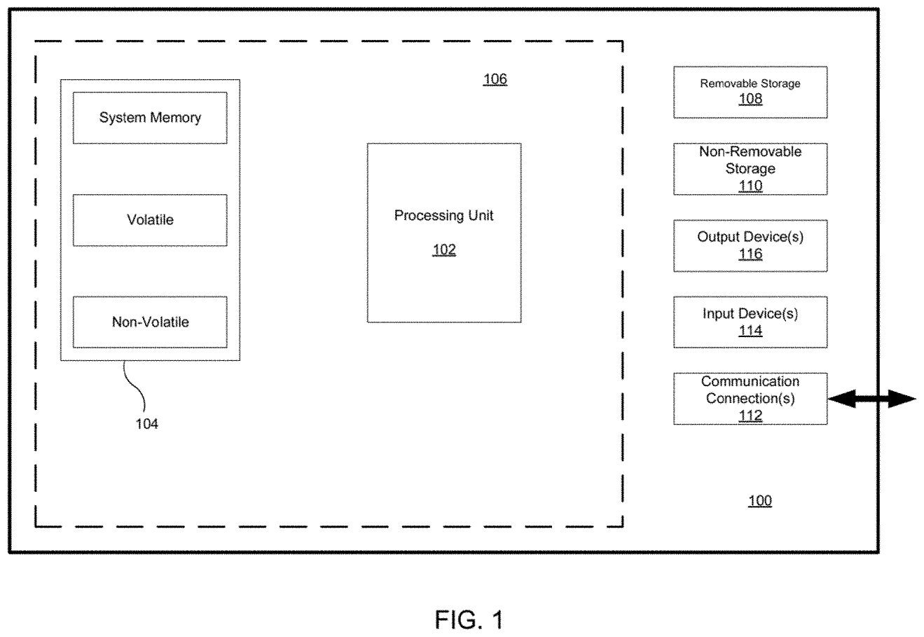

With reference to FIG. 1, an exemplary system for implementing an embodiment of the invention includes a computing device, such as computing device 100, which, in an embodiment, is or includes a smartphone. The computing device 100 typically includes at least one processing unit 102 and memory 104.

Depending on the exact configuration and type of computing device, memory 104 may be volatile (such as random-access memory (RAM)), nonvolatile (such as read-only memory (ROM), flash memory, etc.) or some combination of the two. This most basic configuration is illustrated in FIG. 1 by dashed line 106.

Additionally, the device 100 may have additional features, aspects, and functionality. For example, the device 100 may include additional storage (removable and/or non-removable) which may take the form of, but is not limited to, magnetic or optical disks or tapes. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 arc all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

The device 100 may also include a communications connection 112 that allows the device to communicate with other devices. The communications connection 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, the communication media includes wired media such as a wired network or direct-wired connection, and wireless media such as acoustic, radio-frequency (RF), infrared, cellular and other wireless media. The term computer-readable media as used herein includes both storage media and communication media.

The device 100 may also have an input device 114 such as keyboard, mouse, pen, voice-input device, touch-input device, etc. Further, an output device 116 such as a display, speakers, printer, etc. may also be included. Additional input devices 114 and output devices 116 may be included depending on a desired functionality of the device 100.

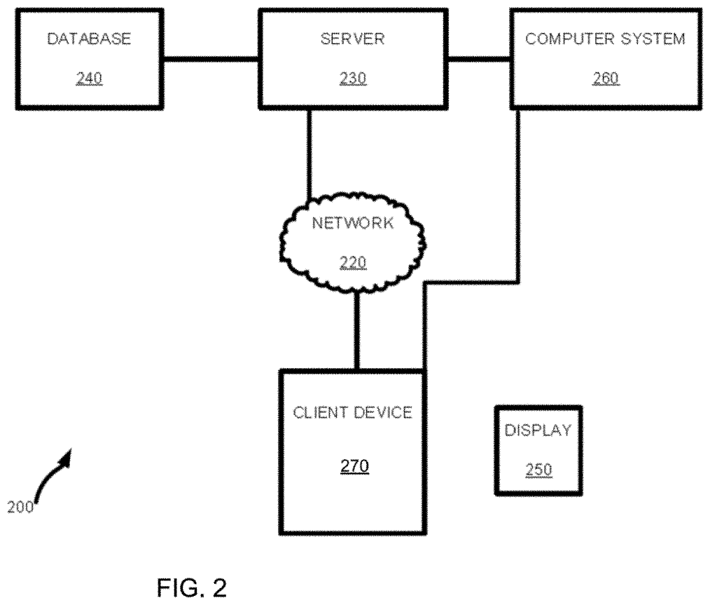

Referring now to FIG. 2, an embodiment of the present invention may take the form, and/or may be implemented using one or more elements, of an exemplary computer network system 200 that, in an embodiment, includes a server 230, database 240 and computer system 260. The system 200 may communicate with an electronic client device 270, such as a personal computer or workstation, tablet or smartphone, that is linked via a communication medium, such as a network 220 (e.g., the Internet), to one or more electronic devices or systems, such as server 230. The server 230 may further be coupled, or otherwise have access, to a database 240 and a computer system 260. Although the embodiment illustrated in FIG. 2 includes one server 230 coupled to one client device 270 via the network 220, it should be recognized that embodiments of the invention may be implemented using one or more such client devices coupled to one or more such servers.

The client device 270 and the server 230 may include all or fewer than all of the features associated with the device 100 illustrated in and discussed with reference to FIG. 1. The client device 270 includes or is otherwise coupled to a computer screen or display 250. The client device 270 may be used for various purposes such as network- and local-computing processes.

The client device 270 is linked via the network 220 to server 230 so that computer programs, such as, for example, a short message service (SMS) application, running on the client device 270 can cooperate in two-way communication with server 230. The server 230 may be coupled to database 240 to retrieve information therefrom and to store information thereto. Database 240 may have stored therein data (not shown) that can be used by the server 230 and/or client device 270 to enable performance of various aspects of embodiments of the invention. Additionally, the server 230 may be coupled to the computer system 260 in a manner allowing the server to delegate certain processing functions to the computer system. In an embodiment, most or all of the functionality described herein may be implemented in a desktop or smartphone application that may include one or more executable modules. In an embodiment, the client device 270 may bypass network 220 and communicate directly with computer system 260.

An embodiment of the invention provides a method of assigning service professionals and delivering goods to customers. An embodiment of the invention provides machine learning, using a combination of data sources, leveraged to efficiently route a service or goods request to a location and cluster jobs for professionals thus minimizing total cost to delivery, passing on savings to the client, and maximizing revenue or minimizing time/resource cost to the professional. Data sources include proprietary data collected on clients requesting services, pros delivering services, plus online available data on supplies (e.g., Home Depot, Lowes, Ikea, etc.), GPS location of the requesting party, GPS data on a photo of a property to be serviced showing exact location of the property, other jobs being requested in proximity or of similar kind, etc.

One or more embodiments may employ the following technologies: Proprietary digital rolodex of professionals, GPS locations, camera such as that included in smartphones, mobile phone, proprietary jobs and quality control data, and quote generation/labor cost data.

Efficient and “smart” routing of services, products and service professionals uses a unique combination of internal and external data according to an embodiment. When combined, services can be delivered to customers faster, and at a lower cost. Savings in cost can be passed on to the customer while increase in revenue can be passed on to the pro. When machine learning and artificial intelligence (AI) are applied to this problem, every routing transaction provides additional data to improve future routing activities resulting in continuous improvement of the routing capability. Data sources includes proprietary data collected on clients requesting services, pros delivering services, plus online available data on supplies (e.g., Home Depot, Lowes, Ikea, etc.), GPS location of the person requesting, GPS data on the photo showing exact location, other jobs being requested in same proximity or of a similar nature to the job requested, etc.

In an embodiment of the invention, a customer communicates an intent to order a good or a service. Such a communication may be made via an electronic device, such as a smartphone, and can be in the form of, for example, a short message system (SMS) communication or voice call. An embodiment identifies the customer and all relevant information such as the good/service desired, data identifying the customer's location, and service provider location data. An embodiment processes the customer's request along with location data to determine specific needs. Needs may be identified using a combination of key word recognition, customer order history data, location data, service provider location data, and customer satisfaction data. An embodiment may use a combination of key term (word and verbal) recognition for automated collection of key information needed for any given request. The recognition and required information can be continually refined based on operational results of the system (i.e., attributes of successful/unsuccessful orders can be fed into the learning system). Manual review can happen for a minority of requests as a stop-gap where the system according to an embodiment is unable to complete the request automatically. Therefore, manual intervention can be based on a dynamic set of parameters. A goal of an embodiment is to drive down manual intervention to zero. Manual intervention attributes can also be fed into the learning model to eliminate future interventions of such type.

An embodiment may include proprietary algorithms to determine who is the optimal supplier of the good or service needed when taking into account a large collection of data including location, similar customer satisfaction, other jobs being requested nearby, cost of the service, the specific customers order history and delivery/traffic data.

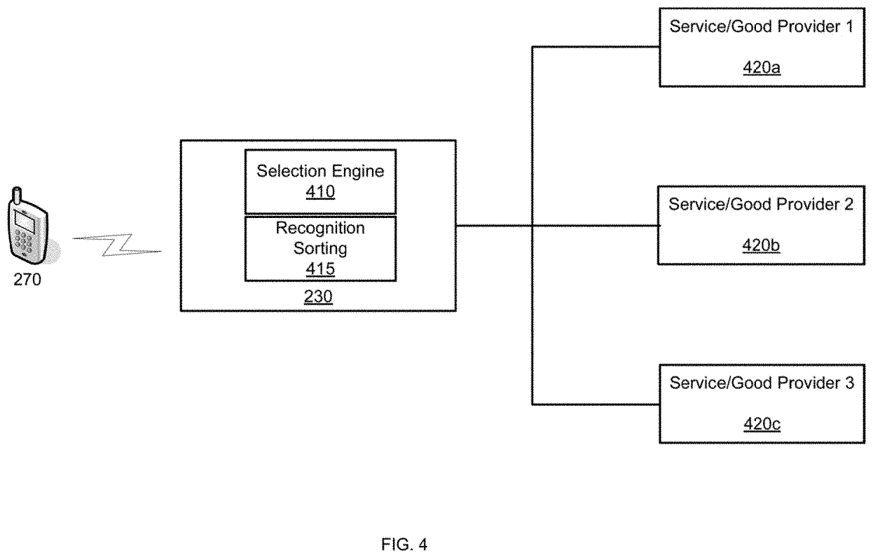

Referring to FIG. 4, and in an embodiment of the invention, a customer initiates an order for a good or service by sending a voice call or an SMS message including text and/or a voice recording from a client device 270 to server 230 using a designated SMS number associated with server 230. In this embodiment, a recognition sorting application 415 executed by the server 230 monitors each call or SMS message incoming from client devices 270 and, based on one or more characteristics associated with the call and/or message, identifies the type of good or service requested by the customer. The one or more characteristics may include one or more keywords, textual or part of a voice recording, in the text message or voice call that indicate the type of good/service requested and that are recognized by artificial intelligence associated with the recognition sorting application 415. Once the requested good/service has been identified by the recognition sorting application 415, and as explained in greater detail below, a selection engine 410 executed by the server 230 identifies an optimal service provider 420 from among a plurality of service providers by which the order should be fulfilled.

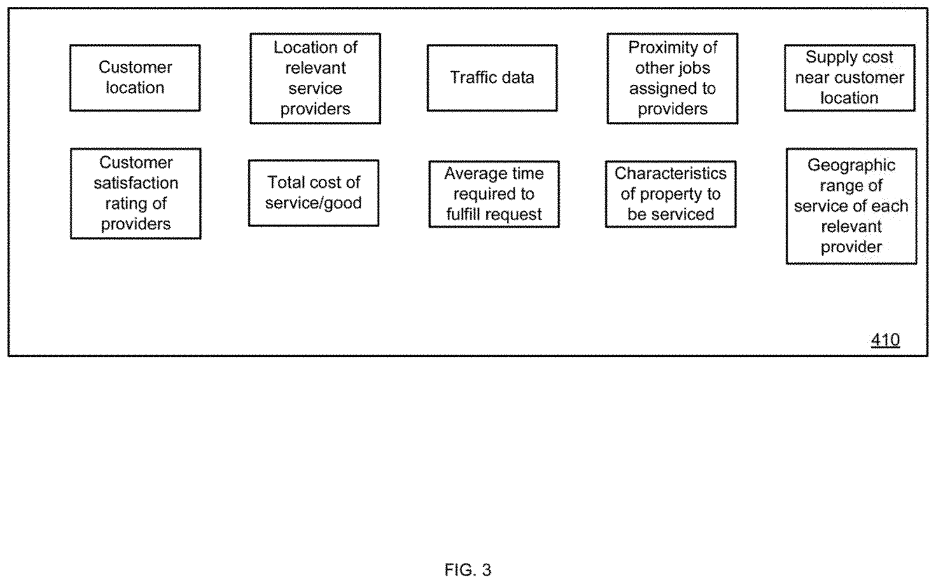

As best illustrated in FIG. 3, the selection engine 410 may determine a list of suitable service providers 420 ranked by scores assigned to each candidate service provider based on one or more combinations of the following non-exhaustive list of factors derived from data sets that may be stored in, for example, database 240:

Location(s) of service(s) to be performed and/or customer, which may be determined using GPS data received from the customer's client device 270;

Location(s) of qualified professional(s);

Geographic location of areas the professionals arc willing to service;

Location(s) and/or cost of materials and tools required to fulfill customer request;

Estimated drive times required for professional to fulfill service;

Factors affecting transport times (e.g., weather forecast, projected traffic patterns, etc.);

Service attributes (e.g., after-hours work, dollar amount of work, work duration, etc.);

Professional attributes (e.g., reputation, skill ratings, professional ratings, etc.);

Attributes of property/location to be serviced (e.g., parking onsite, office check-in, after hours work approved, etc.).

The server 230 through wired or wireless means may then offer the requested service transaction to each of the listed service providers in descending order of rank until the highest-ranked provider accepts the transaction.

The routing and sorting functions may be performed on respective different servers or on the same server such as server 230. In an embodiment, the routing and sorting functions are cloud-based services that also integrate with the service request and fulfillment system.

For example, an order comes into the system from John who needs his gutters cleaned ASAP. Relevant customer data is that John lives in west Bellevue and his house is 4500 square feet in size. Relevant pricing data is that the value of John's home is $1.2 million and the average cost of gutter cleaning in west Bellevue is $250 per thousand square feet. Relevant order history data is that, on average, a pro spends 2.4 hours on site and receives a 4-star review when cleaning gutters in John's neighborhood. Relevant service provider data is that the nearest service provider with availability today is located in Kirkland. Since this is within a radius of less than 5 miles, it is well within the pro's normal working zone and will not impact the cost of the pro's service. This pro has above average ratings on gutter cleaning projects. The second nearest service provider with availability today is located in Redmond. Traffic is expected to be bad this afternoon which will impact this second pro's relative time cost. The optimal service provider (in this case the one located in Kirkland) is notified of the job to which he is assigned. If he rejects, the second-best provider (in this case the one located in Redmond) is assigned to the job. Similarly, if the request is for a good, a similar process is employed, the local supplier is notified of the request and delivery of the good initiated.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. At least one computer-readable medium on which are stored instructions that, when executed by one or more processing devices, enable the one or more processing devices to perform a method, the method comprising the steps of:
receiving from a user via an electronic device a request for a good or a service;
receiving via the electronic device the geographic location of the user;
identifying a type of the requested good or service based on an electronically determined keyword in the request; and
determining an optimal provider of the good or service based on the type of good or service and the geographic location of the user.

2. The medium of claim 1, wherein the method further comprises determining an optimal provider of the good or service based on a geographic location of the optimal provider.

3. The medium of claim 1, wherein the method further comprises determining an optimal provider of the good or service based on a geographic location of an area in which the optimal provider is willing to provide the good or service.

4. The medium of claim 1, wherein the method further comprises determining an optimal provider of the good or service based on one of a location and cost of supplies required to fulfill the request.

5. The medium of claim 1, wherein the method further comprises determining an optimal provider of the good or service based on an estimated drive time required for optimal provider to fulfill the request.

6. The medium of claim 1, wherein the method further comprises determining an optimal provider of the good or service based on projected traffic patterns proximal to a location of the optimal service provider.

7. The medium of claim 1, wherein the method further comprises determining an optimal provider of the good or service based on a rating of the optimal service provider.
